(19) United States
(12) Patent Application Publication
(10) Pub. No.: US 2019/0054663 A1
(43) Pub. Date: Feb. 21, 2019

(54) Method for Manufacturing a Moulding Element of a Mould for Vulcanizing a Tire

(71) Applicant: COMPAGNIE GENERALE DES ETABLISSEMENTS MICHELIN, Clemont-Ferrand, (FR)

(72) Inventors: Stéphane BOLLECKER, Clermont-Ferrand Cedex 9 (FR); Marcin BANCEWICZ, Clermont-Ferrand Cedex 9 (FR); Thong-Art SAKUD, Clermont-Ferrand Cedex 9 (FR)

(21) Appl. No.: 15/761,525

(22) PCT Filed: Sep. 23, 2016
(86) PCT No.: PCT/FR2016/052414

§ 371 Date: Mar. 20, 2018

(30) Foreign Application Priority Data
Sep. 26, 2015 (EP) 1501995

(51) Int. Cl. B29C 33/38; B29C 33/56; B29D 30/06

(52) U.S. Cl. CPC B29C 33/3842; B29C 33/565; B29K 2905/00; B29D 2030/0607; B29K 2883/00; B29D 30/0606

(57) ABSTRACT

Method of manufacturing moulding elements (5) intended to be assembled in a mould for moulding a tire tread, the method comprising: a) a step of aligning a plurality of basic elements (1) on a basic support (4); b) during the alignment step, a step of placing at least one insert (9) between two adjacent basic elements in the alignment, the insert comprising an external part (10) projecting from the two basic elements in a direction away from the basic support (4) and an internal part (11) separating the two basic elements; c) a step of obtaining an intermediate support (3); and d) a step of obtaining at least two moulding elements (5), the two moulding elements (5) being separated by the internal part (11) of the insert (9).

### TECHNICAL FIELD OF THE INVENTION

The invention relates to a method for manufacturing moulding elements for moulds intended for moulding tires provided with a tread comprising a circumferential arrangement of tread patterns.

### PRIOR ART

The mass-production of tires calls for an industrial process that is particularly complex and expensive, involving numerous machines, complex methods, and multiple preparatory phases. A side-effect of the complexity of the process is that it is very rigid, reducing the possibilities for modifying the configuration or arrangement after a production line has been set up. This rigidity is particularly applicable to the moulds intended for the vulcanizing and moulding phases.

Now, vehicles are increasingly being produced in limited production runs with specific features that make these vehicles unique and attractive in comparison with those that are mass-produced. Among the specific features offered, the tires are often one of the strong differentiating features.

There is therefore a significant and increasing need to improve the flexibility of the tire manufacturing processes. Furthermore, there is an increasing need to simplify and facilitate the preparation of tires provided with attractive specific features.

Application FR 3014351 describes a method for manufacturing moulding elements for moulds intended for moulding tires provided with a tread comprising a circumferential arrangement of tread patterns, that is able to partially meet these objectives.

This method comprises:
a) a step consisting in aligning a plurality of basic liners made from a flexible material to form a tread circumference basic portion;
b) a step consisting in generating, from the tread circumference basic portion, an intermediate support, corresponding to the tread circumference portion;
c) a step of obtaining an unfinished moulding element from the intermediate support;
   each of the basic liners corresponding to one pattern of the circumferential arrangement of the tread of the tire that is to be moulded.

According to this method, the unfinished moulding element needs to be separated into a plurality of sections which can be used for later moulding operations. The separation step is particularly complex and lengthy to perform because it involves cuts for each of the numerous sections, under conditions of high precision, without adversely affecting the quality of the elements obtained.

There is therefore a need for a method that is simpler, less expensive, and more rapid, preserving the quality of the parts obtained.

### SUMMARY OF THE INVENTION

It is one object of the invention to provide a manufacturing method that makes it easier to modify the visual characteristics of the tires.

It is another object of the invention to provide a manufacturing method that makes it possible to reduce wastage of raw materials when modifying the visual characteristics of the tires.

Yet another object is to provide a method that makes it possible to optimize the manufacture of the tires, particularly in terms of the mould-preparation phase.

In order to do this, the invention provides a method of manufacturing moulding elements intended to be assembled in a mould for moulding a tire tread, each moulding element being obtained by the use of a basic element made of a flexible material, the method comprising:

a) a step of aligning a plurality of basic elements on a basic support;
b) during the alignment step, a step of placing at least one insert between two adjacent basic elements in the alignment, the insert comprising an external part projecting from the two basic elements in a direction away from the basic support and an internal part separating the two basic elements;
c) a step of obtaining an intermediate support from the plurality of aligned basic elements, the said intermediate support flanking the external part of the insert;
d) a step of obtaining, from the intermediate support, at least two moulding elements, the two moulding elements being separated by the internal part of the insert.

By virtue of the method according to the invention, the moulding elements are obtained in a way that is simpler, more rapid and more economical than in the method hitherto used. The numerous cuts to be made for each moulding element are replaced by a simple step of separating elements that have already been moulded individually on account of the presence of the inserts. This method allows a great deal of flexibility in the configuration of the moulds. Because each basic liner corresponds to a pattern of the tread of the tire that is to be moulded, the resulting moulding elements enjoy this same property. By using moulding elements with different patterns, the architecture of the tread can be adapted or modified without the need to replace the entire mould. According to the mould type requirements and the quantities required for each type of moulding element, the quantities produced for each type can easily be adjusted because the intermediate mould makes it possible to accommodate the basic liners according to the production requirements for these various types of moulding elements, for example favouring one type over another.

The simultaneous manufacture of a plurality of moulding elements makes it possible to optimize the manufacturing process, with a simplification of tooling and a reduction in material wastage.

The intermediate mould allows the basic liners to be grouped together in a way that is simple and rapid, and with precise positioning. The step of moulding the intermediate support is thereby optimized, with the overall use of space being optimized and with particularly advantageous precision of embodiment.

One single moulding phase therefore allows several moulding elements or segments to be obtained.

According to one advantageous embodiment, the inserts are steel plates.

Advantageously, the steel inserts are subjected to a shaping step before they are inserted.

According to another advantageous embodiment, the inserts are textile plies. Such an embodiment, with flexible textile plies, makes it extremely easy to set out the plies with an infinite number of different profiles, with much easier placement.

The textile plies may be woven or intermingled. Advantageously, the textile plies have a density that is high enough to avoid any interpenetration between adjacent zones of intermediate support or of moulding element that are separated by the said plies. Use is advantageously made of textile plies with compositions such as alkali-earth silicate fibres.

Use is advantageously made of inserts that have resistance to high temperatures, at least up to substantially 700° C., and preferably of water-repellent inserts.

Each one of the inserts is advantageously substantially rigid in the direction normal to the main plane of the said insert.

Moreover, use is advantageously made of inserts that are chemically neutral with respect to the material of the moulding element.

Advantageously, the inserts have a thickness of 0.2 to 4 mm (in the case of textile) and in excess of 0.2 mm in the case of metal.

According to one advantageous alternative form, during the step of insert placement, a step is provided that consists in leaving a thin layer of moulding element under at least part of the inserts, so as to create links between the adjacent zones of moulding element. This embodiment makes it possible to provide an unfinished moulding element that has a plurality of interconnected individual elements, which is easy to handle because it comes in a single piece until the elements have been definitively separated. Furthermore, the step that consists in removing the intermediate support is made easier by the fact that the multiple individual elements are joined together.

According to another alternative form of embodiment, the moulding elements comprise at least an additional thickness of material and are machined down to the final size before being assembled in the mould. This step makes it possible to optimize the precision of the moulding elements.

According to another alternative form of embodiment, the intermediate support is made from a sacrificial material.

According to yet another alternative form of embodiment, the unfinished moulding element is made from a reusable material.

According to yet another advantageous embodiment, the method comprises a prior step of creating a basic master (or template) making it possible to obtain corresponding basic liners.

According to yet another advantageous embodiment, the method comprises a step of removing the inserts by destroying them using high-pressure water.

In another alternative form, the basic liner is made of silicone, and preferably of silastene. This then yields the possibility of reusing the basic liner for other production runs.

The invention also provides a mould comprising a support on which a plurality of moulding elements obtained by the method described hereinabove are circumferentially aligned.

The invention also provides a tire obtained by moulding and vulcanization using a mould comprising a plurality of circumferential liners/segments obtained by the manufacturing method described hereinabove.

In one advantageous alternative form, the tire comprises a tread provided with a plurality of patterns arranged in circumferential alternation, each of the patterns in the circumferential arrangement corresponding to a pattern of a basic liner used in the manufacturing method described hereinabove.

### DESCRIPTION OF THE FIGURES

Other features and advantages of the invention will become apparent from the following description, given by way of non-limiting example, with reference to the attached drawings in which:

FIG. 1 schematically depicts the main elements involved in creating an intermediate support from an alignment of basic elements, with the insertion of dividing inserts;

FIG. 2 is a schematic perspective depiction of one example of a basic element;

FIG. 3a is a schematic depiction in elevation of an intermediate support collaborating with a plurality of basic elements, inserts extending both into the intermediate support and between the basic elements;

FIG. 3b is a perspective view of the assembly depicted in FIG. 3a;

FIG. 4 is a schematic perspective depiction of one example of an intermediate support in which the inserts are partially embedded, after removal of the basic elements;

FIG. 5 is a schematic perspective depiction of one example of an unfinished moulding element, in which the inserts are partially embedded, after removal of the intermediate support;

FIG. 6 is a schematic perspective depiction of one example of a moulding element after separation.

In the following description, elements which are substantially identical or similar will be denoted by identical references.

### DETAILED DESCRIPTION OF THE INVENTION

### Definitions

A “tire” means all types of resilient tread, whether or not it is subjected to an internal pressure.

The “tread” of a tire means a quantity of rubbery material delimited by lateral surfaces and by two main surfaces, one of which is intended to come into contact with a road surface when the tire is being driven on.

A “sacrificial material” means a material that is easy to remove by destruction, such as for example by breaking it or by cutting it, after moulding of the intended element.

A “reusable material” means a material, the mechanical properties of which allow it to be reused several times over in an industrial tire-moulding method.

FIG. 2 illustrates one example of a basic element 1 made from a flexible material such as, for example, silicone, and preferably silastene. The basic element has a substantially elongate profile with, at each of its ends, a securing feature, preferably in the form of a dovetail.

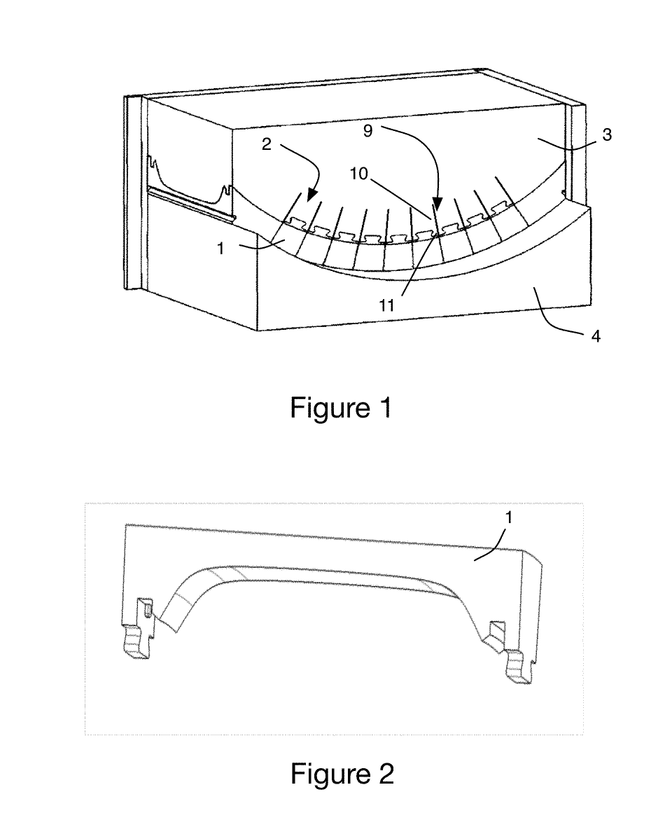

As shown in FIG. 1, a plurality of basic elements 1 are aligned transversely against one another on a basic support 4 so as to reproduce a portion of tread 2. In order to keep the basic elements correctly assembled against one another, one or more pressing elements such as blocks, made from a material of a hardness that is higher than that of the basic elements are provided, for example on each side of the basic elements positioned at the lateral ends.

Each basic element 1 is separated from its neighbour by an insert 9 acting as a divider. The zone acting as a divider is referred to hereinafter as the internal part 11. This internal part 11 is advantageously extended towards the basic support 4, as far as the latter. As an alternative, the internal part is interrupted before it reaches the basic support 4. This undivided space will be used in the step of moulding the moulding elements 5 to form a connecting zone joining the moulding elements 5 together. In this alternative form, the interconnected moulding elements may for example be handled as a single unit before being separated later. The connecting zone is made small enough that separating the elements from one another is a simple matter.

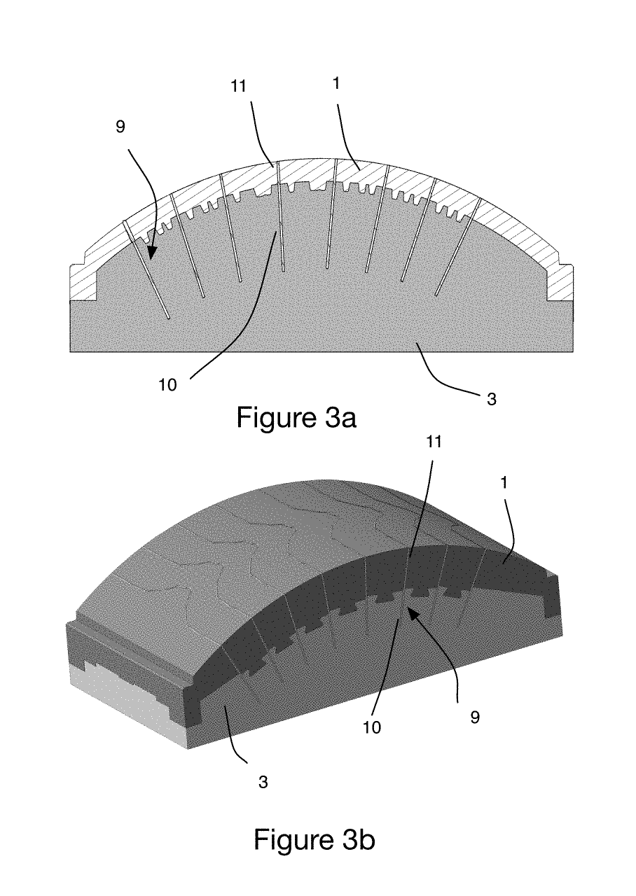

The assembly of basic elements 1 that are aligned and separated by the inserts allows an intermediate support 3 to be moulded that reproduces the inverse image of the portion of tread. This intermediate support 3 is advantageously made of a sacrificial material such as plaster. FIGS. 3a and 3b illustrate in greater detail (in elevation and in perspective) the result obtained when the intermediate support 3 has been moulded and the basic elements are still in place. Each of the inserts 9 comprises an internal part 11 (separating two basic elements) and an external part 10 projecting from the basic elements 1 so as to be embedded in the intermediate support 3. According to one exemplary embodiment, the external part projects by at least 1 cm on average, in the length of the component.

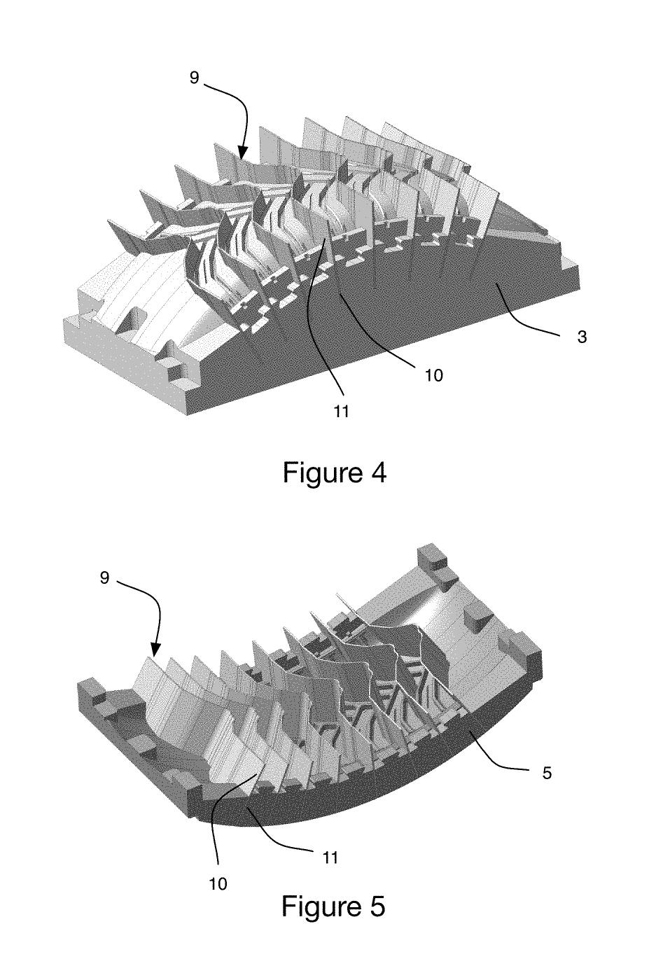

When the basic elements 1 are removed, as shown for example in FIG. 4, the internal parts 11 become free, and the inserts 9 at this stage are held by the external parts 10. The freed internal parts 11 will, in the next step, allow the moulding elements 5 to be delimited and separated, during the moulding thereof, against the intermediate support 3.

FIG. 5 shows an assembly of moulding elements 5, after moulding and removal of the intermediate support 3, for example by destroying it. The figure provides a clear picture of the inserts 9 with the external parts 10 freed again and the internal parts 11 separating each of the moulding elements 5. As these are elements which may be used several times over in the production phases, the moulding elements 5 are made from a “reusable material” such as a light metal alloy, for example aluminium. This material also offers the advantage of being easy to mould and to machine. In the example illustrated in FIG. 5, the internal parts 11 of the inserts 9 extend along the entire flank of the moulding elements.

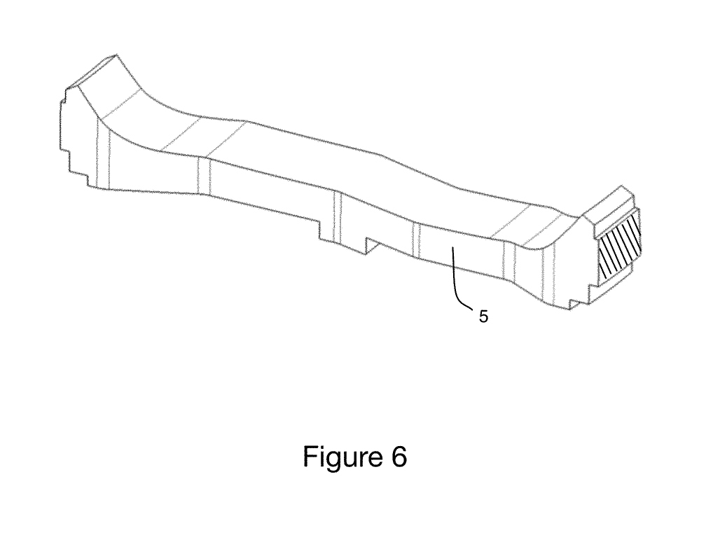

FIG. 6 shows the result of the next step after removal of the inserts and separation of the individual moulding elements.

The invention is not limited to the examples described and shown and various modifications can be made thereto without departing from its scope.

### REFERENCES USED IN THE FIGURES

| | |
|---|---|
| 1 | Basic element |
| 2 | Tread |
| 3 | Intermediate support |
| 4 | Basic support |
| 5 | Moulding element |
| 9 | Inserts |
| 10 | External part (projecting from the basic elements) |
| 11 | Internal part (separating two basic elements) |

1. A method of manufacturing moulding elements intended to be assembled in a mould for moulding a tire tread, each moulding element being obtained by the use of a basic element made of a flexible material, the method comprising:
a) an alignment step of aligning a plurality of basic elements on a basic support;
b) during the alignment step, a step of placing at least one insert between two adjacent of said basic elements in the alignment, the insert comprising an external part projecting from the two basic elements in a direction away from the basic support and an internal part separating the two basic elements;
c) a step of obtaining an intermediate support from the plurality of aligned basic elements, said intermediate support flanking the external part of the insert; and
d) a step of obtaining, from the intermediate support, at least two moulding elements, the two moulding elements being separated by the internal part of the insert.

2. The manufacturing method according to claim 1, wherein the inserts are steel plates.

3. The manufacturing method according to claim 2, wherein the steel inserts are subjected to a shaping step before they are inserted.

4. The manufacturing method according to claim 1, wherein the inserts are textile plies.

5. The manufacturing method according to claim 4, wherein the textile plies are woven or intermingled.

6. The manufacturing method according to claim 4, wherein the textile plies have a density that is high enough to avoid any interpenetration between adjacent zones of intermediate support or of moulding element that are separated by said plies.

7. The manufacturing method according to claim 1, wherein the inserts have resistance to high temperatures, at least up to substantially 700° C.

8. The manufacturing method according to claim 1, wherein each one of the inserts is substantially rigid in the direction normal to the main plane of said insert.

9. The manufacturing method according to claim 1, wherein the inserts are water-repellent.

10. The manufacturing method according to claim 1, wherein the inserts are chemically neutral with respect to the material of the moulding element.

11. The manufacturing method according to claim 4, wherein the inserts have a thickness of from 0.2 to 4 mm.

12. The method according to claim 1, wherein, during the insert placement step, a step is provided that consists in leaving a thin layer of moulding element under at least part of the inserts, so as to create links between the adjacent zones of moulding element.

13. The method according to claim 1, comprising a step of removing the inserts by destroying them using high-pressure water.

14. A mold comprising a support on which a plurality of moulding elements obtained by the method according to claim 1 are circumferentially aligned.
